(19) United States
(12) Patent Application Publication
(10) Pub. No.: US 2008/0134946 A1
(43) Pub. Date: Jun. 12, 2008

(54) Removeable Table Top Attached to a Rolling Container and Method of Attaching the Table Top

(76) Inventors: Gabriel Alonso, Weston, FL (US); Gonzalo Aponte, Weston, FL (US)

Correspondence Address: LERNER GREENBERG STEMER LLP, P O BOX 2480, HOLLYWOOD, FL, 33022-2480, US

(21) Appl. No.: 11/954,165

(22) Filed: Dec. 11, 2007

Related U.S. Application Data
(60) Provisional application No. 60/874,124, filed on Dec. 11, 2006.

(51) Int. Cl. A47B 13/08; B23P 11/00

(52) U.S. Cl. 108/50.11; 29/525.01

(57) ABSTRACT

The invention is a multifunctional table top that can be repeatedly attached to and removed from the elongated or telescopic handle assembly of a rolling container, such as, for example, a roller bag used for transporting clothing during travel. The table top includes a support member for supporting an object such as, for example, a portable computer. The table top also includes a connector removably securing the support member to the handle assembly of the rollable container such that the support member is supported above the handle of the handle assembly. By securing the support member in this manner, the connector positions the support member so that the handle of the handle assembly cannot interfere with the placement or the use of objects placed on the support member. The invention is also a method of removably attaching a multifunctional table top to the elongated or telescopic handle assembly of a rolling container.

### CROSS-REFERENCE TO RELATED APPLICATION

This application claims the benefit under 35 U.S.C. § 119(e) of my provisional application No. 60/874,124 filed Dec. 11, 2006. As far as possible under the rules, the prior application is herewith entirely incorporated by reference.

### BACKGROUND OF THE INVENTION

1. Field of the Invention

The invention relates to a multifunctional table top that can be repeatedly attached to and removed from the elongated or telescopic handle assembly of a rolling container, such as, for example, a roller bag used for transporting clothing during travel.

2. Description of the Related Art

It is well-known to design and construct an item of luggage with a built-in table that can be used to support objects. For example, published U.S. Patent Application No. 2005/0098402 A1 to Cohen, Issued U.S. Pat. No. 6,471,019 to Miller, Issued U.S. Pat. No. 5,941,352 to Lee, Issued U.S. Pat. No. 4,966,258 to Hawley, Issued U.S. Pat. No. 4,856,627 to Polatov, and Issued U.S. Pat. No. 4,412,604 to Bell et al. each disclose an item of luggage with a built-in table.

Issued U.S. Pat. No. 5,529,322 to Barton discloses a transport device that can be used to transport luggage. The transport device has a tray that can serve as a work surface.

Issued U.S. Pat. No. 6,439,134 B1 to Ryberg teaches several embodiments of a portable work station that engages with the extensible handle support members of an item of luggage. Several embodiments disclosed therein include a rod assembly extending between the ground surface and the bottom of the work surface. This rod assembly together with the engaged extensible handle support members of the item of luggage support the work surface. One embodiment disclosed therein includes a strap running between the lower front side of the item of luggage and the bottom of the work surface. This strap does not support the work surface, but rather pulls the work surface towards the lower front side of the item of luggage so that the applied tension enables the work surface to frictionally engage the extensible handle support members of the item of luggage.

In all of the embodiments disclosed in U.S. Pat. No. 6,439,134 B1, the work surface is located below the handle when the work surface is attached to the item of luggage. When placing a laptop or notebook computer on the work surface, the handle and the portion of the handle support members extending above the work surface limit the rearward position of the screen of the notebook computer. This means that the viewing angle of the screen cannot be adjusted as desired by the user. Additionally, all of the embodiments can only be used with items of luggage constructed with exactly two parallel support members connected to a common handle.

### BRIEF SUMMARY OF THE INVENTION

With the foregoing and other objects in view there is provided, in accordance with the invention, a table top for removably attaching to a handle assembly of a rollable container. The table top includes a support member for supporting an object; and a connector removably securing the support member to the handle assembly of the rollable container such that the support member is supported above a handle of the handle assembly.

In accordance with an added feature of the invention, the connector secures the support member to the handle of the handle assembly.

In accordance with an additional feature of the invention, the connector secures the support member to the handle assembly such that the support member securely sits on top of the handle of the handle assembly.

In accordance with another feature of the invention, the connector includes a flexible material wrapping around the handle of the handle assembly.

In accordance with an added feature of the invention, a stabilizing member is attached to the support member and stabilizes the support member against an elongated member of the handle assembly. The stabilizing member may be a panel.

In accordance with a further feature of the invention, a hinge attaches the stabilizing member to the support member.

In accordance with a further added feature of the invention, a securing connector is attached to the support member and releasably secures a portable computer to the support member.

In accordance with a further additional feature of the invention, the securing connector includes an elastic cord and a plurality of holes formed in the support member; and the cord extends through the plurality of holes and over a portion of the portable computer.

In accordance with yet a further feature of the invention, the support member is formed with a plurality of ventilation holes allowing heat to dissipate from a portable computer.

In accordance with yet a further added feature of the invention, a stabilizing member is attached to the support member and stabilizes the support member against an elongated member of the handle assembly; and the support member and the stabilizing member form a computer briefcase for storing a portable computer.

In accordance with yet a further additional feature of the invention, a stabilizing member stabilizes the support member against an elongated member of the handle assembly; a hinge attaches the stabilizing member to the support member; and a supporting member is pivotally attached to the stabilizing member. The support member is formed with at least one receiving structure receiving the supporting member to fix an angle formed by the support member and the stabilizing member.

In accordance with another added feature of the invention, a connector is provided to mate with the docking system of a portable computer to secure the portable computer on the support member.

With the foregoing and other objects in view there is also provided, in accordance with the invention, a method of attaching a table top to a rollable container. The method includes removably attaching a support member for supporting an object to a handle assembly of a rollable container such that the support member is supported above a handle of the handle assembly.

In accordance with an added mode of the invention the method includes stabilizing the support member against an elongated member of the handle assembly with a stabilizing member.

With the foregoing and other objects in view there is also provided, in accordance with the invention, a table top for removably attaching to a handle assembly of a rollable container. The table top includes a support member for supporting an object; and a connector removably securing the support member to the handle assembly of the rollable container such that the handle of the handle assembly is not higher than the support member.

Business travelers are always looking for ways to be more productive. Today's business people need to carry their portable computers with them at all times during business travel. Internet access is now provided in hotel lobbies, airport terminals, retail stores, warehouses and even across cities. Notebook computers are rather uncomfortable to use during travel. If a business traveler needs to stand in line for a period of time and wants to work on his/her notebook computer, the traveler needs to hold the computer with one arm and type (and use the pointing device) using only the other hand. This approach results in a very uncomfortable working position that no one can sustain for a relative long period of time. Also, this position enables other people standing in line to see the information displayed on the screen. It is so bad that typically a person would rather not use his laptop at all while standing up in line.

If the person is not standing in line, but is waiting in a seating area, the person who wants to work on their portable computer often tries to find a seat first. If a seat is available, the person sits down and uses the computer on their lap. While this is better than standing up holding the computer and typing single-handed, this can still become rather uncomfortable and risky as the computer on the person's lap may get hot and heavy over time. Working for long periods of time sitting down with a computer on one's lap can also bring neck and back pains as people typically arch their backs and necks to be able to read the screen and type.

Although uncomfortable and risky, it is still very common to see people today at the airport and in other waiting areas using their portable computers either standing up, sitting on the floor, or sitting on a chair with the computer on their lap.

The invention taught herein is a very versatile solution to these problems. Travelers can easily turn their roller bags into a rigid and stable tabletop in a matter of seconds. Among other things, this tabletop could fit a portable computer, significantly improving the ergonomics of working on the portable computer while traveling. As roller bag handles are height adjustable, the table top height can easily be adjusted for working standing up or sitting down. Even when installed, a person standing in line can walk and push a roller bag and be completely mobile while working on a computer. The person's forward movement is not limited as the line advances.

The design of the table top also allows it to be useful for many other applications. It can also be used as a coffee table to hold snacks and drinks as well as an extension to the airplane seat's folding table, giving the user a bigger and more comfortable working space while flying. When working on a desk, it can also be used to give the notebook computer a slight angle, improving the ergonomics of using the notebook computer even when working on a table or desk. It can also be very useful for other “roller” type of applications such as tool boxes, coolers, picnic bags, etc. Designs can include a variety of options and features such as cup holders, snack containers, cheese cutting table, tool holders and more.

Other features which are considered as characteristic for the invention are set forth in the appended claims.

Although the invention is illustrated and described herein as embodied in a table top constructed to be removably attached to a rolling container and method of attaching the table top, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE SEVERAL VIEWS OF THE DRAWING

FIG. 1 is a diagram showing a first exemplary embodiment of a removable table top secured to a rollable container;

FIG. 2A is a side view showing a more detailed view of the first exemplary embodiment of the removable table top secured to a rollable container;

FIG. 2B is a side view showing a more detailed view of an altered version of the first exemplary embodiment of the removable table top secured to a rollable container;

FIG. 3 is a plan view showing the first exemplary embodiment of the removable table top in an unfolded and unattached state;

FIG. 4 is a plan view showing a second exemplary embodiment of a removable table top in an unfolded and unattached state;

FIG. 5 is a side view showing a more detailed view of the second exemplary embodiment of the removable table top secured to a rollable container;

FIG. 6 is a diagram showing additional features of the second exemplary embodiment of the removable table top;

FIG. 7 shows second exemplary embodiment of the removable table top supporting a notebook computer;

FIG. 8 is a front view of the second exemplary embodiment of the removable table top sitting on top of a rollable container;

FIGS. 9A-9D are side views for illustrating a rapid deployment process for installing the removable table top;

FIGS. 10A, 10B and 10C show the second embodiment of the removable table top constructed as a notebook computer briefcase;

FIG. 11 is a diagram showing a mobile person using the removable table top;

FIGS. 12A and 12B show a third exemplary embodiment of a removable table top;

FIG. 13 shows a fourth exemplary embodiment of a removable table top; and

FIG. 14 shows a fifth exemplary embodiment of a removable table top.

### DESCRIPTION OF THE PREFERRED EMBODIMENTS OF THE INVENTION

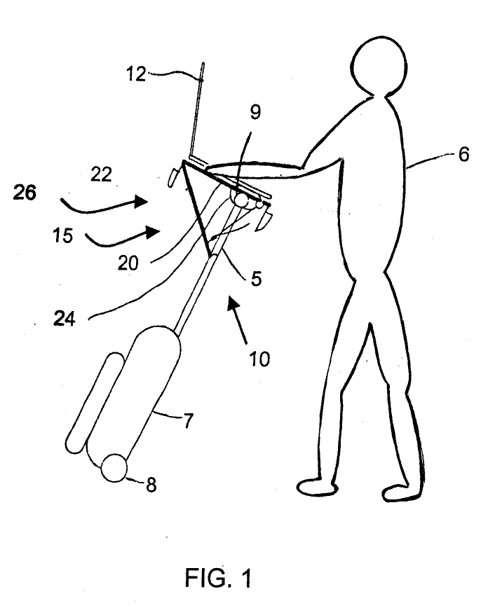

Referring now to the figures of the drawing in detail and first, particularly, to FIG. 1 thereof, there is shown a first exemplary embodiment of a table top 15 that is removably attached or secured to a rollable container 7. In this example, the container 7 is shown as an item of luggage, and is specifically shown as a roller bag that is typically used for transporting clothing and other personal articles while traveling. The table top 15 is used for supporting an object, such as, for example, a portable computer. A well-known portable computer, for example, is a laptop or notebook computer 12.

The table top 15 is constructed to be removeably attached or secured to the elongated handle assembly 10 of the container 7. The elongated handle assembly 10 includes a handle 9 provided at the end of one or more elongated members 5. The table top 15 can be attached to a handle assembly 10 having one, two, or even more elongated members 5. The elongated handle assembly 10, which is shown, is a well-known type in which the elongated member or members 5 can retract into or at least towards the container 7 when the handle 9 is not being used. When desired, the elongated member or members 5 can be telescopically extended away from the container 7 so that a person 6 can conveniently reach the handle 9. The container 7 has one or more wheels or rollers 8 so that a person can use the handle 9 to pull or push the container 7 on the rollers 8.

The table top 15 may also be used with many other types of containers 7, which can be rolled and which have elongated, extended, or telescopic pulling handles. For example, roller briefcases, roller crates, roller picnic coolers, portable electronic gear cases, portable rollable computer briefcases, portable rollable toolboxes, and portable rollable tradeshow cases to name a few. In fact it is possible to use any portable device that has wheels or rollers and one or more elongated members with a handle that a person can grasp in order to roll or wheel the portable device. Such elongated members may or may not be telescopic.

The table top 15 includes a supporting surface or support member, which may be, for example, a panel 20 that can be secured to the elongated handle assembly 10 of the container 7 when a person 6 has a desire to use the table top 15. When the person 6 no longer desires to use the table top 15, the panel 20 can be removed from the elongated handle assembly 10 of the container 7 until the next time the table top 15 is needed. The support member or panel 20 is used for supporting an object, such as, for example, a portable computer.

FIG. 1 shows that the panel 20 of the table top 15 is attached to the elongated handle assembly 10 of the container 7 such that the top surface of the panel 20 is above the level of the top surface of the handle 9. The fact that the handle 9 does not extend above the top surface of the panel 20 when the panel 20 is attached provides the advantage that the handle 9 will not interfere with the placement or operation of any objects placed on top of the panel 20. For example, if a notebook computer 12 is placed on top of the panel 20, the display screen of the notebook computer 12 can be freely adjusted to any desired viewing angle. If the panel 20 were attached to the handle assembly 10 of the container 7 in a manner such that the handle 9 extended above the panel 20, which is not the case with the invention, the handle 9 could limit the desired rearward position of the display screen of the notebook computer 12.

It is also shown that no additional support legs need to provide support between the panel 20 of the table top 15 and the ground. The panel 20 of the table top 15 is exclusively supported above the ground by the elongated handle assembly 10 of the container 7. This enables the table top 15 to be compact and very convenient to carry when traveling since bulky legs do not need to be transported in addition to the removable table top 15.

The panel 20 of the table top 15 is attached to the handle assembly 10 of the container 7 such that the panel 20 is at least approximately even with the level of the handle 9. Preferably, the panel 20 is attached to the handle assembly 10 of the container 7 such that the panel 20 is above the level of the handle 9. Any one of many different ways could be used in order to achieve the attachment. The invention should not be construed as being necessarily limited to any particular type of component, configuration of cooperating components, or connector for attaching the table top 15 to the handle assembly 10 of the container 7.

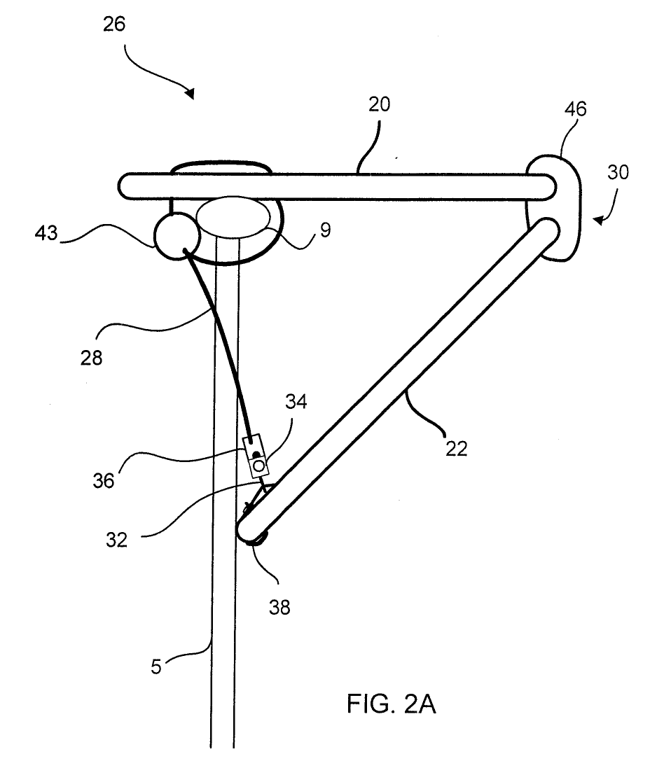

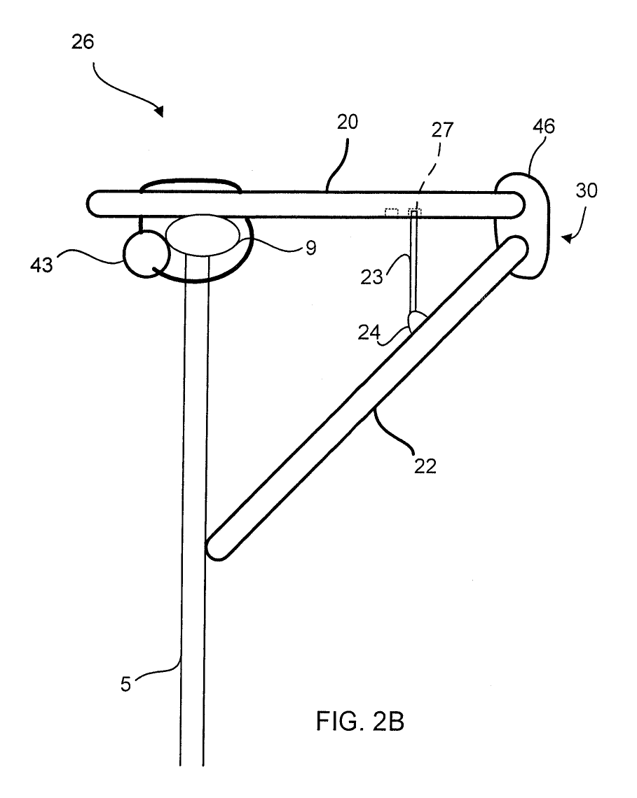

FIG. 2A is a diagram showing one possible example of securely attaching the table top 15 to the elongated handle assembly 10 of a rollable container 7. A connector 26 is used to securely attach the table top 15 to the elongated handle assembly 10. In this embodiment, the panel 20 rests on top of the handle 9 and the connector 26 firmly secures the panel 20 to the handle 9.

In the exemplary embodiment shown in FIG. 2A, the connector 26 includes at least one cord or strap 28 that extends from the bottom of the panel 20. The cord or strap 28 could be made from any of a number of different types of materials. One option is to provide the strap 28 as a flat woven piece of flexible material having a width of about ¾ of an inch. To secure the panel 20 to the elongated handle assembly 10, the strap 28 is led to a position below the handle 9, and is then wrapped around the handle 9 and tightened to form a tight loop around the handle 9. Locking piece 43 may be provided to lock the strap 28 in the adjusted position around the handle 9. In this manner the panel 20 is attached or secured to the handle 9. For many applications, securing the panel 20 only to the handle 9 in this manner will provide enough stability. Pads, which are not illustrated, could be attached to the bottom surface of the panel 20 to assist in providing a suitable area for receiving the handle 9. The handle 9 could then be placed against the pads and the panel 20 would then be secured to the handle 9 in the manner described above.

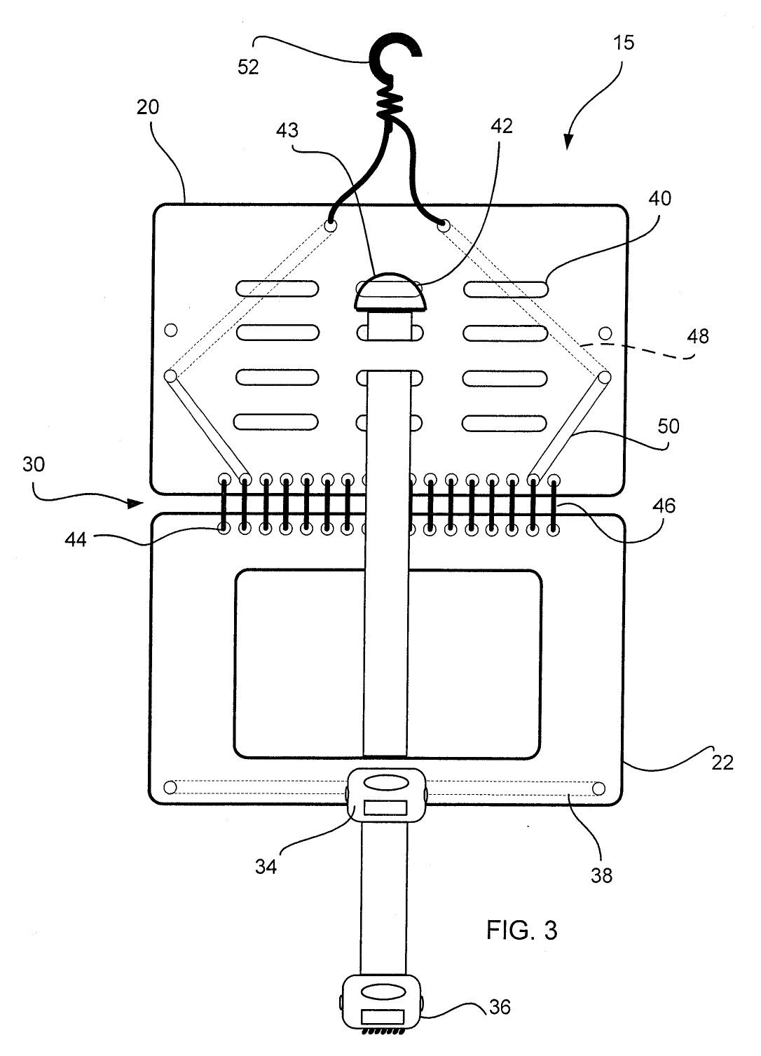

In order to provide additional stability, the table top 15 may additionally include one or more stabilizing members to provide support between the panel 20 and the elongated member or members 5 of the handle assembly 10. In the exemplary embodiments a stabilizing member is shown and is constructed, for example, as a stabilizing panel 22 that is pivotally attached to the panel 20 by a hinge 30. One example of constructing such a hinge 30 is by providing corresponding holes 44 (shown in FIG. 3) in the panels 20, 22 and by coiling a wire 46 through the holes 44.

In the example shown in FIG. 2A, after the strap 28 is wrapped around the handle 9 to secure the panel 20 to the handle 9, the strap 28 is tightly connected near the lower edge of the stabilizing panel 22. By connecting the strap 28 to the lower edge of the stabilizing panel 22, the lower edge of the stabilizing panel 22 is biased against the elongated member or members 5, which enables the upper edge of the stabilizing panel 22 to provide additional support for the panel 20. The panel 20 now provides a very stable work surface. Before the strap 28 is fully tightened, the position of the stabilizing panel 22 against the elongated member or members 5 can be adjusted in order to adjust the angle of the panel 20 on the handle 9 as desired.

Many different types of connection mechanisms could be used to connect the strap to the stabilizing panel 22. For example, Velcro, buckles, and loop mechanisms are just a few of the possible options. The exemplary embodiment shown in FIG. 2A uses a cooperating female connector 34 and male connector 36 to connect the end of the strap to the stabilizing panel 22. The female connector 34 is attached to the lower edge of the stabilizing panel 22 by a short length of cord or strap 32. An end of the strap 28 has the male connector 36 which mates with the female connector 34. Of course the connection of the female and male connectors could easily be reversed, and as stated other types of cooperating connectors could be used. In this embodiment, it is only important that the cord 28 is tightened around the handle 9 and is then used to apply a tensioning force to the stabilizing panel 22 to secure the stabilizing panel 22 against the elongated member or members 5 of the handle assembly 10.

In order to provide even more stability to the connection between the panel 20 and the handle assembly 10, additional tension can be applied to the strap 28 after it has been wrapped around the handle 9 and attached to the strap 32 on the stabilizing panel 22. For this purpose, an elastic tensioning cord 38 can be run along the lower edge of the stabilizing panel 22 to apply a somewhat lateral biasing pressure against the attached and tightened straps 28 and 32. The stabilizing panel 22 and the panel 20 together with the elongated members 5 of the handle assembly 10 form a triangular shape, which is known to be very stable and sturdy.

FIG. 2B shows a slightly changed version of the exemplary embodiment of the table top 15 that was shown in FIG. 2A. In this example, the strap 28 is only wrapped and tightened around the handle 9 to secure the panel 20 to the handle 9. An additional supporting member 23 is pivotally attached to the stabilizing panel 22 by a hinge 24, and a series of receiving structures 27, for example, notches or holes are formed in the bottom surface of the panel 20. The end of the supporting member 23 is inserted into one of the receiving structures 27 to fix the angle formed by the panel 20 and the stabilizing panel 22. When an object is placed on the panel 20, the weight of the object will securely bias the lower edge of the stabilizing panel 22 against the elongated member or members 5 and additional support is thereby provided for the panel 20. The supporting member 23 could be formed, for example, by a plate or by a piece of hard wire formed with an edge that can be inserted into a desired one of the receiving structures 27.

The table top 15 can be used with a portable computer even when the table top 15 is not attached to the handle assembly 10. For example, the table top 15 can be used as a lap table or can be used on an existing table, such as an airline food tray that folds down from the back of a seat. When the table top 15 is placed on a table it can be used, for example, to support a portable computer at a slight angle with respect to a horizontal surface.

FIG. 3 is a plan view of the version of the table top 15 that is shown in FIG. 2A, but in an unfolded and unattached state so that both the underside of the panel 20 and the upper side of the stabilizing panel 22 can be seen. A person would normally fold the panel 20 and the stabilizing panel 22 together at the hinge 30 for convenience during storage or during transport. The panel 20 has a plurality of ventilation holes 40 formed therein that allow heat to dissipate from a notebook computer 12 that is placed on top of the panel 20. The locking piece 43 may be constructed, for example, as a D-ring 42 that is attached to one end of the strap 28. The strap 28 is lead through several of the ventilation holes 40 located in the center of the panel 20 to secure the D-ring 42 to the bottom of the panel 20. The other end of the strap 28 is attached to the male connector 36 that will be attached to the female connector 34 at or extending from the upper side of the stabilizing panel 22 in order to securely bias the stabilizing panel 22 against the elongated handle assembly 10 of the container 7. The corresponding holes 44 in the stabilizing panel 22 and in the panel 20, and the wire 46 of the hinge 30 may be seen in this view. The position of the tensioning cord 38, which is on the other side of the stabilizing panel 22 and cannot be seen in this view, is illustrated using dashed lines. A securing connector 48 is illustrated using dashed lines for a portion that can not be seen in this view and using a solid line for the portion that can be seen in this view. The securing connector 48 in this exemplary embodiment is implemented as a cord 50 and is used to secure a laptop computer 12 to the top side of the panel 22. The portion of the securing connector 48, which is on the other side of the panel 22 and which cannot be seen in this view, is slid over the edges of the keyboard portion of the laptop computer 12. A hook 52 can be used to provide even more stability when the person 6 using the removable table top 15 is standing. The hook 52 can simply be hooked onto a belt loop of the pants of the person 6 who is standing. In the example, the hook 52 is attached to two connecting ends of the cord 50.

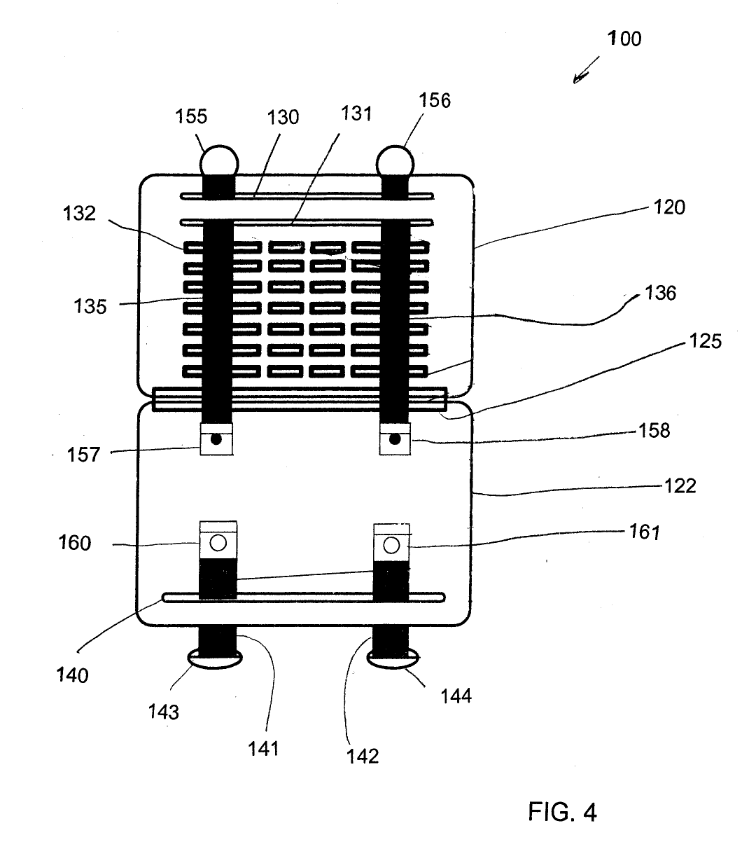

FIG. 4 is a plan view showing a second exemplary embodiment of a table top 100 in an unfolded and unattached state. The panel 120 and the stabilizing panel 122 are bound together by a hinge or binding system 125. This hinge or binding system 125 allows the panels 120, 122 to open up and close like a book. The panel 120 has a series of holes or perforations identified with reference numerals 130, 131, and 132. These perforations 130, 131, and 132 have several functions. They make the device lighter. When a portable computer is placed on top of the panel 120, the perforations 130, 131, and 132 allow for ventilation of the portable computer. The perforations 130, 131 are also used for holding the straps 135, 136 in place. Although the illustration shows the straps 135, 136 passing through the perforations 130 and 131, any of the perforations 132 could also be used for customized strap configurations if needed.

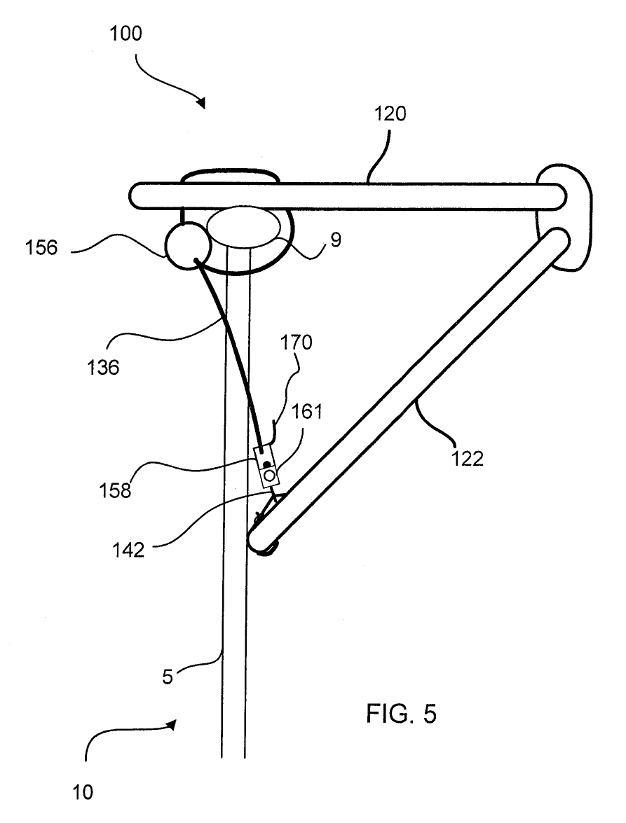

Different perforation patterns and/or alternative strap holding settings may be used for different applications and styles. The stabilizing panel 122 also has one or more holes or perforations 140. These perforations 140 are used to hold down a strap 141 with a female connector 143 and a strap 142 with a female connector 144. The multiple wide and narrow perforations 130, 131, 132, and 140 provide a universal design allowing for multiple straps 135, 136 from the panel 120 and multiple cooperating straps 141, 142 from the stabilizing panel 122 to be used. This universal design can be adjusted to operate with a rollable container 7 including a handle assembly 10 with one, two, or even more elongated members 5. Such a universal design also allows the user to improve the stability of the table top 100 by moving the table top 100 forward or backward to balance it in accordance with the center of gravity of the rollable container 7. The strap 135 has a ring 155 at one end and a male connector 157 at the other end. The strap 136 has a ring 156 at one end and a male connector 158 at the other end. The male connectors 157, 158 each fit through a respective ring 155, 156 for attaching the panel 120 to the handle 9 of the handle assembly 10. The male connectors 157, 158 then connect into the female connectors 160, 161 of the straps 141, 142. When positioned correctly, strapped, buckled up and trimmed, the table top 100 creates a triangular shape with resistance against the telescopic poles or elongated members 5 of the handle assembly 10. This creates a sturdy platform as is shown in FIG. 5.

FIG. 5 is a side view of the second exemplary embodiment of the table top 100 when it is installed on the handle 9 and against the elongated member or members 5 of a handle assembly 10. Only the straps 136, 142 are shown in this view. The end of the strap 136 with the male connector 158 is grasped, is wrapped around the handle 9, and is brought back in and tightened through the ring 156 to hold the panel 120 to the handle 9. The end of the strap 136 with the male connector 158 is then brought to the female connector 161 and the male connector 158 is mated with the female connector 161. As the user installs the table top 100 and pulls on the remainder 170 of the strap 136, the stabilizing panel 122 creates resistance against the elongated members 5. By increasing or reducing this resistance the user can adjust the angle of the table top 100. This is a very useful feature for portable computer applications as the user can then adjust the balance and keyboard angle to his/her comfort.

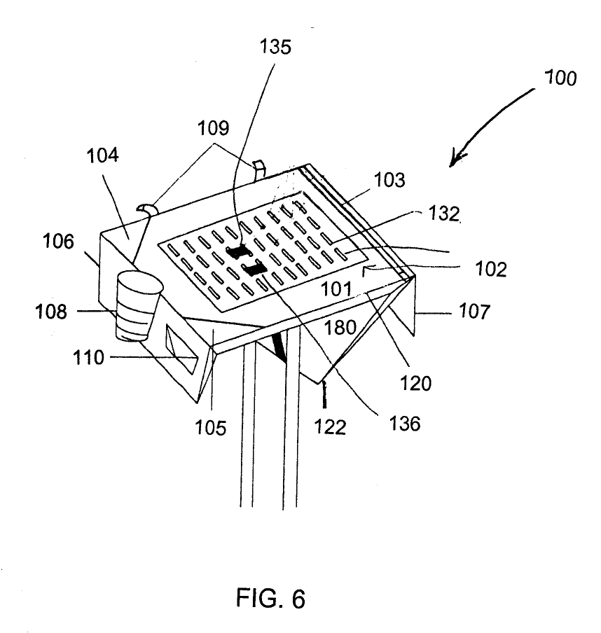

FIG. 6 is a diagram showing additional features of the second exemplary embodiment of a removable table top 100. In this example, the straps 135, 136 have been placed through the perforations 132, rather than through the perforations 130 and 131 as was shown in FIG. 4. The table top 100 has also been provided with an optional cloth cover 101. The cloth cover 101 on the panel 120 has a window opening 102 for exposing the perforations 132. This allows the user to customize the location and configuration of the straps 135, 136 according to the specific design of the handle system 10 of a rollable container 7. The window opening 102 also allows for ventilation when using a portable computer. The cloth cover 101 on the panel 120 also features a strap system 103, 104, and 105 to secure the portable computer in place while in use. There are two flaps on the cloth cover 101 on the top panel 120. The forward flap 106 and the rear flap 107. These flaps 106 and 107 provide multiple functions. The forward flap 106 may feature a number of storage compartments 110 for things like reading glasses, mobile phones, personal music players, and documents, for example. The forward flap 106 may also contain a cup holder 108, for example. When the user is ready to uninstall the table top, the user flips both the forward flap 106 and the rear flap 107 upwards and joins them together on top of the computer system, securing it in place for storage. A binding system 109, which is formed by securing straps, buckles and/or Velcro, may be used to keep the panel 120 and the stabilizing panel 122 secured together while not in use.

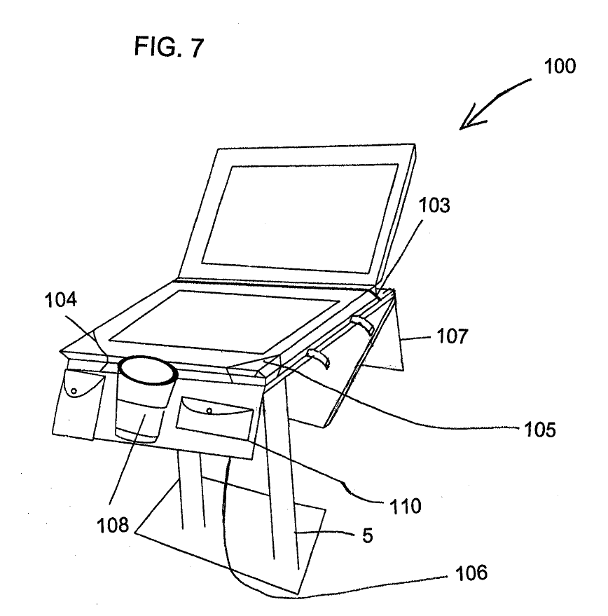

FIG. 7 shows the removable table top 100 supporting a notebook computer 12. This illustration shows the strap system 103, 104, and 105 securing the notebook computer 12 in place. It also shows the rear flap 107 and the forward flap 106, which has storage compartments 110 and a cup holder 108.

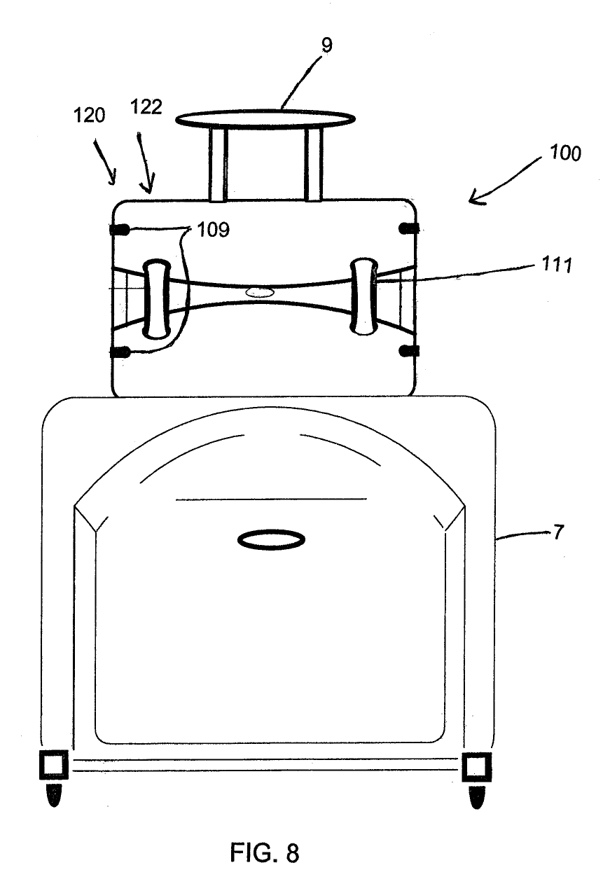

FIG. 8 is a front view of the table top 100 sitting on top of a rollable container 7, specifically a rollable briefcase, while the table top 100 is not in use. In this configuration, however, the table top 100 is set up for rapid deployment. Note that the panel 120 and the stabilizing panel 122 are now held in their closed position and bound together by the binding system 109. Note how the portable computer, which cannot be seen, is safely protected in place between the panel 120 and the stabilizing panel 122. Additional side straps 111 also help keep the portable computer safely in place while being transported on top of the rollable briefcase.

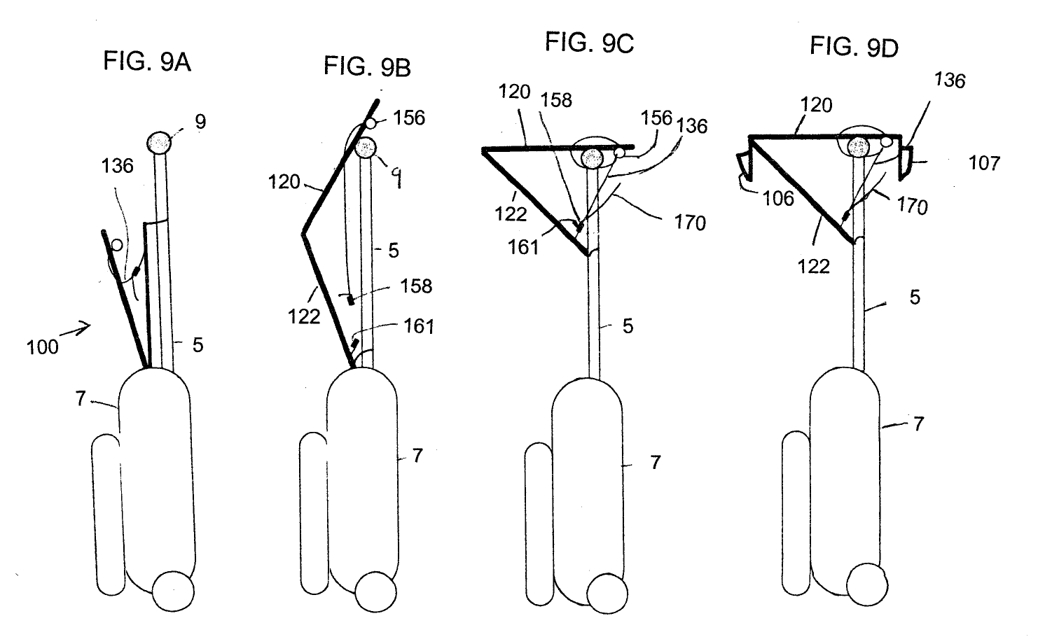

FIGS. 9A-9D are side views for illustrating a process for installing the table top 100 when it is being carried on top of the rollable container 7 and in front of the handle assembly 10. This rapid deployment method is very convenient for business travelers who want to use the table top 100 for a portable computer application during travel. First, in FIG. 9A, the table top 100 is opened slightly to gain access to one or more straps 135, 136 that may be provided. In FIGS. 9A-9D, only strap 136 and the components cooperating with strap 136 are shown. In FIG. 9B, the user releases the male connector 158 from the female connector 161 and positions the panel 120 on the handle 9 as shown. Then in FIG. 9C, the strap 136 is inserted through the ring 156 and then the male connector 158 is attached to the female connector 161. The remainder of the strap 170 is pulled to adjust the angle of the table top 100. As shown in FIG. 9D, once the table top 100 is installed, the user then opens the forward flap 106 and the rear flap 107 to expose the top surface of the panel 120, which serves as a table top area.

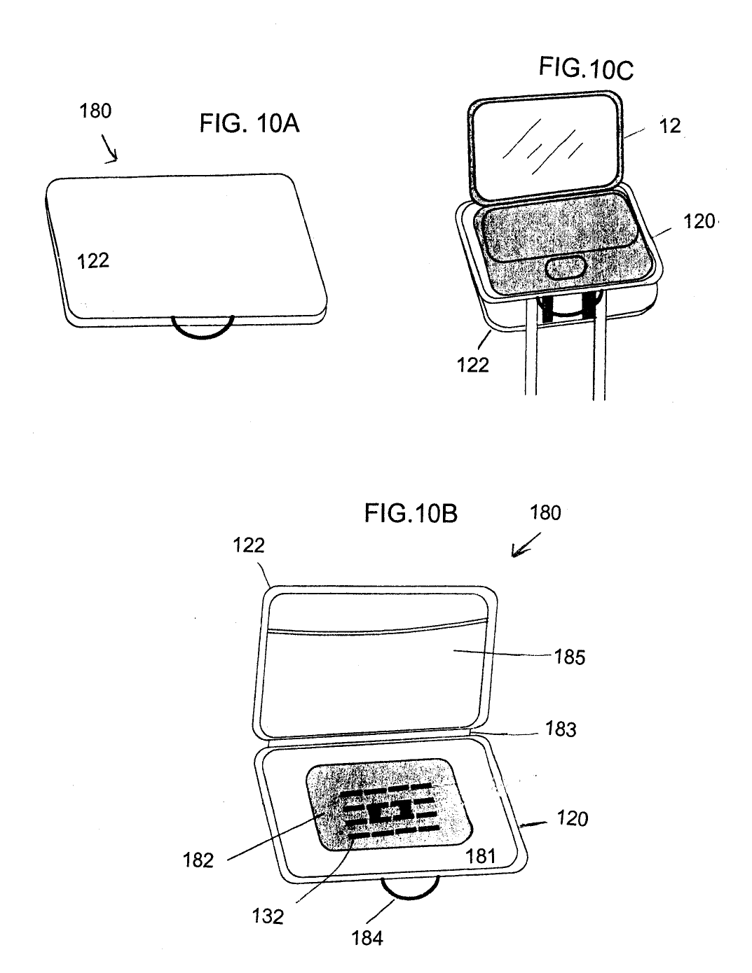

FIGS. 10A and 10B show the table top 100 constructed as a notebook computer briefcase 180. FIG. 10A shows the briefcase 180 in a closed state for storing and transporting a notebook computer. FIG. 10B shows the stabilizing panel 122 constructed to form the top portion of the briefcase 180 and shows the panel 120 constructed to form the bottom portion of the briefcase 180. It also shows an interior cloth cover 181 constructed with a window opening 182 for accessing the perforations 132. The cloth cover 181 is constructed with a hinge 183 that allows the panels 120, 122 to open a full 360 degrees. A handle 184 and pocket 185 add briefcase type features. The computer briefcase 180 opens up to function as a table top as shown FIG. 1C. The same connection system that has been previously described is used to attach the computer briefcase 180 to the handle assembly 10.

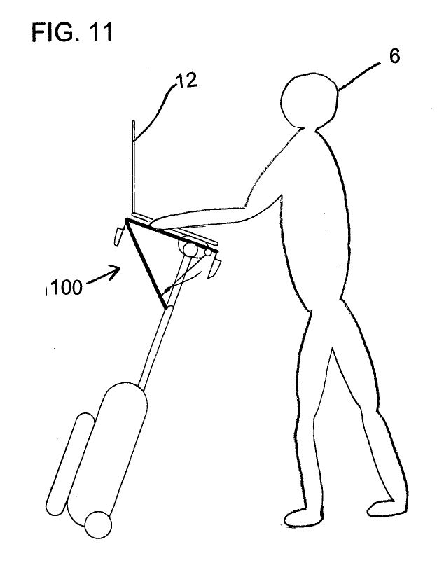

FIG. 11 illustrates how a person 6 who is using a notebook computer 12 on the table top 100 can still be mobile while the table top 100 is installed. This feature is very useful for business travelers who are working while waiting in line and need to move forward every so often as the line advances.

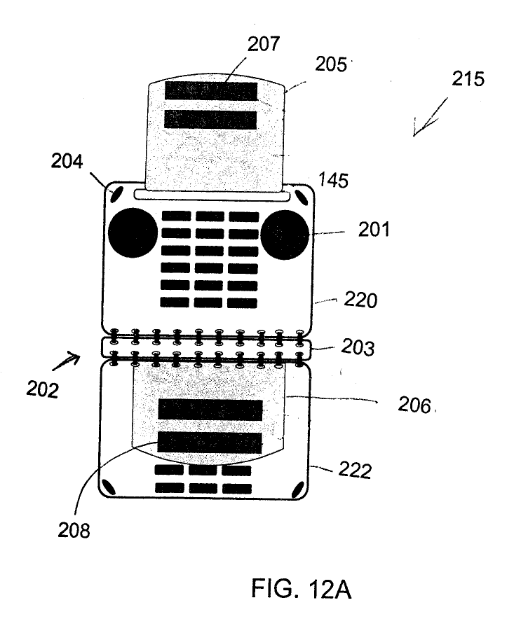

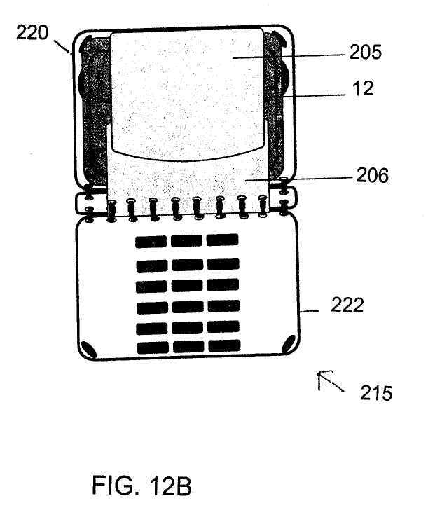

FIG. 12A shows a third exemplary embodiment of the table top 215. The panel 220 is constructed with a connection mechanism for securing the panel 220 to the handle 9 of a rollable container 7 in the manner previously described. The panel 220 may be formed with cup holders 201. Additional perforations 204 may be provided for holding elastic cords in place, for example. The hinge system 202 includes a spacer plate 203 that spaces the panel 220 away from the stabilizing panel 222 when the table top 215 is folded together to a closed position. The spacer plate 203 is sized to provide enough space so that a notebook computer 12 can be fit between the panel 220 and the stabilizing panel 222 when they are folded together. The hinge system 202 preferably allows the panel 220 and the stabilizing panel 222 to open up a full 360 degrees. Flap 205 is attached to the panel 220 and flap 206 is attached to the hinge system 202. Flaps 205 and 206 have one or more cooperating strips of Velcro 207, 208 so that the flaps can be attached together so that the flaps 205, 206 hold the notebook computer 12 against the panel 220. In this manner a secure storage space between the panels 220 and 222 is provided for the notebook computer 12. The table top 215 with the notebook computer 12 stored therein could be held on the handle assembly 10 of the container 7 in a manner similar to that shown in FIG. 8.

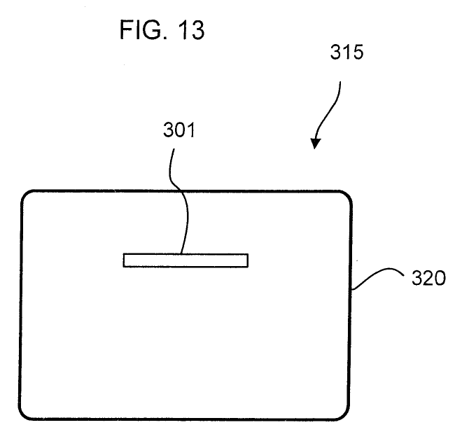

FIG. 13 shows a fourth exemplary embodiment of a removable table top 315. Only the panel 320 that attaches to the handle 9 of the container 7 is shown. Non-illustrated features are similar to those already described. In this embodiment, the panel 320 is constructed to secure a notebook computer 12 in place on the panel 320 by physically attaching to the docking mechanism of the notebook computer 12. A connector 301, which is attached to the panel 320, is provided to mate with the docking mechanism of the notebook computer 12. Since the connector 301 will be securely fastened to the docking mechanism of the notebook computer 12, the panel 320 does not have to be sized to extend underneath the entire notebook computer 12 and could be made significantly smaller using this option. This makes the system smaller and lighter.

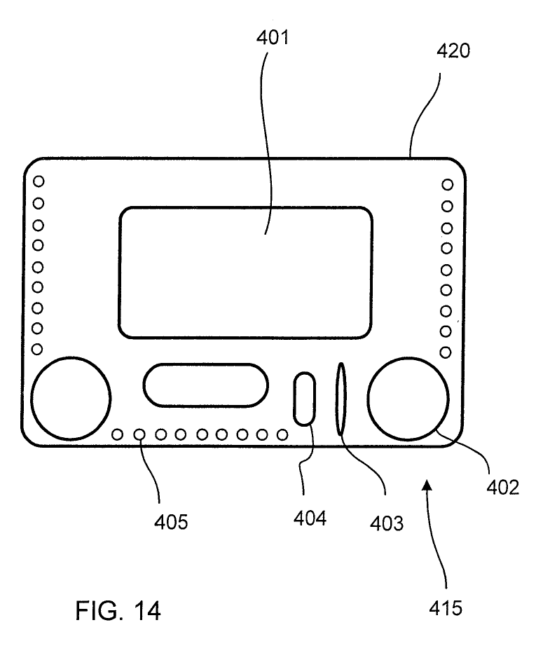

FIG. 14 shows a fifth exemplary embodiment of a removable table top 415. Only the panel 420 that attaches to the handle 9 of the container 7 is shown. Non-illustrated features are similar to those already described. In this embodiment, the panel 420 is constructed to hold fishing tackle and could be attached to a portable fishing cooler, for example. A mesh basket 401 is provided to hold multiple items. One or more cup holders 402 may be provided. A knife slot 403 for holding a knife, a slot 404 for holding pliers, and a plurality of holes 405 for holding fishing lures may also be provided.

We claim:

1. A table top removably attaching to a handle assembly of a rollable container, comprising:
a support member for supporting an object; and
a connector removably securing said support member to the handle assembly of the rollable container such that said support member is supported above a handle of the handle assembly.

2. The removable table top according to claim 1, wherein:
said connector secures said support member to the handle of the handle assembly.

3. The removable table top according to claim 2, wherein:
said connector secures said support member to the handle assembly such that said support member securely sits on top of the handle of the handle assembly.

4. The removable table top according to claim 1, wherein:
said connector includes a flexible material wrapping around the handle of the handle assembly.

5. The removable table top according to claim 1, further comprising:
a stabilizing member attached to said support member and stabilizing said support member against an elongated member of the handle assembly.

6. The removable table top according to claim 5, further comprising:
a hinge attaching said stabilizing member to said support member.

7. The removable table top according to claim 6, wherein said stabilizing member is a panel.

8. The removable table top according to claim 1, further comprising:
a securing connector attached to said support member and releasably securing a portable computer to said support member.

9. The removable table top according to claim 8, wherein:
said securing connector includes an elastic cord and a plurality of holes formed in said support member; and
said cord extends through said plurality of holes and over a portion of the portable computer.

10. The removable table top according to claim 1, wherein:
said support member is formed with a plurality of ventilation holes allowing heat to dissipate from a portable computer.

11. The removable table top according to claim 1, further comprising:
a stabilizing member attached to said support member and stabilizing said support member against an elongated member of the handle assembly;
said support member and said stabilizing member forming a computer briefcase for storing a portable computer.

12. The removable table top according to claim 1, further comprising:
a stabilizing member stabilizing said support member against an elongated member of the handle assembly;
a hinge attaching said stabilizing member to said support member; and
a supporting member pivotally attached to said stabilizing member;
said support member formed with at least one receiving structure receiving said supporting member to fix an angle formed by the support member and the stabilizing member.

13. The removable table top according to claim 1, further comprising:
a connector mating with a docking system of a portable computer to secure the portable computer on the support member.

14. A method of attaching a table top to a rollable container, which comprises:
removably attaching a support member for supporting an object to a handle assembly of a rollable container such that the support member is supported above a handle of the handle assembly.

15. The method according to claim 14, which comprises:
stabilizing the support member against an elongated member of the handle assembly with a stabilizing member.

16. A table top removably attaching to a handle assembly of a rollable container, comprising:
a support member for supporting an object; and
a connector removably securing said support member to the handle assembly of the rollable container such that a handle of the handle assembly is not higher than said support member.
